(19) United States
(12) Patent Application Publication
(10) Pub. No.: US 2008/0164804 A1
(43) Pub. Date: Jul. 10, 2008

(54) MASK HAVING RAISED SUPPORTING BODIES

(76) Inventor: Frank YANG, Guanyin Township (TW)

Correspondence Address: HDSL, 4331 STEVENS BATTLE LANE, FAIRFAX, VA, 22033, US

(21) Appl. No.: 11/757,358

(22) Filed: Jun. 2, 2007

(30) Foreign Application Priority Data
Jan. 4, 2007 (TW) 096100299

(51) Int. Cl. H01J 29/02

(52) U.S. Cl. 313/402

(57) ABSTRACT

A mask structure having raised supporting bodies is provided between an anode plate and a cathode plate to form a gate electrode layer. The mask is provided thereon with a plurality of apertures that are arranged at intervals. The plate surface of the mask is provided with a plurality of raised supporting bodies that are arranged on the plate surface of the mask at intervals and are adhered to the cathode plate to form a support and separation between the mask and the cathode plate. Finally, the surface of the raised supporting body is provided with an electrode layer that is electrically connected with the cathode plate, thereby providing the necessary power supply for the mask serving as the gate electrode layer. In this way, the mask structure formed in single construction can be packaged directly with the cathode plate and the anode plate. Therefore, in addition to reduce the manufacturing cost, the risk of oxidization of the cathode electron emission sources occurred during the high-temperature sintering can be avoided.

### BACKGROUND OF THE INVENTION

1. Field of the Invention

The present invention relates to a gate structure, and in particular to a gate structure that can be applied to a field emission displayer.

2. Description of Prior Art

With the promotion of modern technologies and novel materials, the development of displayers has s significant change from traditional bulky CRT (Cathode Ray Tube) displayer to modern FPD (Flat Panel Display). Besides the structure of FPD is lighter and thinner than that of the traditional displayer, the dpi (dot per inch) of the picture and the brightness of FPD are superior to those of the traditional television. Therefore, FPD is widely used to the displayers of various dimensions from a small screen of a mobile phone to a large-sized outdoor advertisement board, so that the FPD becomes more and more popular in the market.

The field emission displayer is a kind of FPD that develops very rapidly in recent years, and the characteristic thereof lies in that it can emit light by itself without providing any other back light source. Therefore, in comparison with other FPD that needs a back light source, the field emission displayer has an excellent brightness, a wider range of viewing angles, low electricity consumption and fast response. Further, with the application of nanomaterials, the field emission displayer has developed to a more mature product.

The existing structure of the field emission displayer is a tri-pole structure, which includes an anode plate and a cathode plate. A supporting body is provided between the anode plate and the cathode plate, thereby forming a partition for a vacuum region between the anode plate and the cathode plate. Further, the anode plate includes an anode substrate and a fluorescent layer provided on the substrate. The cathode plate includes a cathode substrate and a plurality of cathode electron emission sources provided on the substrate, and corresponds to the fluorescent layer on the anode plate. Finally, a gate electrode layer is provided between the anode substrate and a cathode substrate. With the gate electrode layer providing a potential to drain the cathode electron emission sources to generate electronic beams, the electronic beams can collide with the fluorescent layer directly and generate a light.

The traditional gate structure utilizes a mask made of metal, ceramic or glass as a gate structure, in which the mask structure has to be separated from the cathode substrate with a certain distance. Therefore, an insulating layer made of silicon oxide or low-temperature glass glue is provided between the mask and the cathode substrate. The insulating layer is also referred to as a dielectric layer that can be provided on the mask or the cathode substrate to match the different openings of the gate. Further, during the manufacturing procedure, the relationship among the coefficients of expansion of the gate structure, the insulating layer and the cathode substrate should be taken in consideration, thereby avoiding the excess expansion generated by the high temperature, which may adversely cause the dislocation and deformation of the structure and affect the positions of electronic beams. However, the above-mentioned structure has to be manufactured by means of sintering in high temperature, and the high-temperate manufacturing may reduce the electron generation efficiency of the carbon nanotube that serves as a cathode electron emission source of the cathode substrate. In order to solve the poor efficiency of the carbon nanotube, the manufacturing procedure has to be modified to manufacture the cathode electron emission sources by electrophoresis or other methods after the completion of the insulating layer. Although this modified manufacturing procedure can solve the above-mentioned problem, the manufacturing cost increases relatively, causing another serious disadvantage.

A later-developed manufacturing procedure is to manufacture the insulating layer on the mask structure, and then combine the mask with the cathode substrate to form a complete cathode plate structure having a gate. However, such method can be only suitable for manufacturing a small-sized mask. When a large-sized mask is manufactured, the problem of deformation may still occur and thus it is necessary to be improved.

### SUMMARY OF THE INVENTION

In view of the above drawbacks, the present invention is to provide a mask structure having raised supporting bodies. A plurality of raised supporting bodies is provided on the mask structure that serves as a gate metallic layer, thereby acting as a structure for supporting the mask and forming a separation from the cathode plate adhered to the supporting bodies. In this way, the mask structure formed in single construction can be packaged directly with the cathode plate and the anode plate. Therefore, when the packaging procedure is performed by means of high-temperature sintering, the reduction in the production efficiency of the carbon nanotube serving as the cathode electron emission source can be avoided.

In order to achieve the above objects, the present invention provides a mask structure having raised supporting bodies, which is provided between an anode plate and a cathode plate to form a gate electrode layer. The mask is provided thereon with a plurality of apertures that are arranged at intervals. The plate surface of the mask is provided with a plurality of raised supporting bodies that are arranged on the plate surface of the mask at intervals and are adhered to the cathode plate to form a support and separation between the mask and the cathode plate. Finally, the surface of the raised supporting body is provided with an electrode layer that is electrically connected with the cathode plate, thereby providing the necessary power supply for the mask serving as the gate electrode layer.

### BRIEF DESCRIPTION OF THE DRAWINGS

FIG. 1 is a top view showing the mask structure of the present invention;

FIG. 2 is a front view showing the mask structure of the present invention;

FIG. 3 is an assembled view showing the structure of the present invention; and

FIG. 4 is a schematic view showing the operation of the present invention.

### DETAILED DESCRIPTION OF THE INVENTION

The technical contents of the present invention will be described with reference to the accompanying drawings.

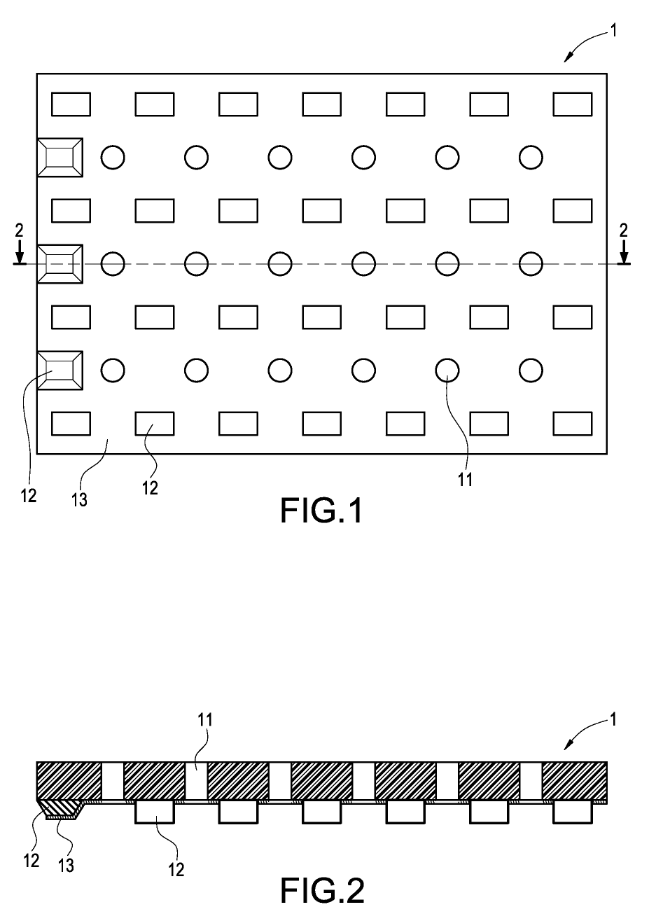

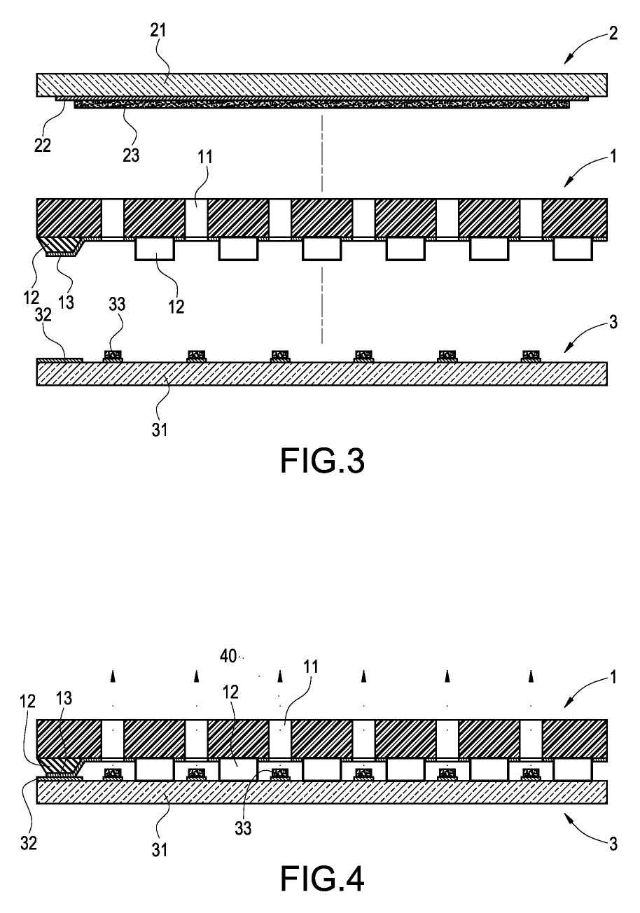

FIGS. 1 and 2 are the top view and the front view of the present invention, respectively. As shown in the drawings, the mask 1 is provided between an anode plate 2 and a cathode plate 3 (FIG. 3). The mask 1 is made of silicon dioxide, glass or other insulating materials, and the thickness thereof is in a range between 0.02 mm and 2 mm. The mask 1 is provided thereon with a plurality of apertures 11 that are arranged at intervals. The diameter of the aperture is in a range between 1 μm and 2 μm, which allows an electron beam drained from the cathode plate 3 to pass through (this will be described later). The plate surface of the mask 1 is provided with a plurality of raised supporting bodies 12 that are adhered to the cathode plate 3 to form a support and separation for the mask 1, thereby facilitating the generation of electron beams. The plurality of raised supporting bodies 12 is arranged on the plate surface of the mask 1 at intervals. The raised supporting bodies 11 are formed on the plate surface of the mask 1 by means of LIGA procedure. The height of the raised supporting body is in a range between 1 μm and 50 μm. The raised supporting bodies 12 are made of silicon dioxide, glass or other insulating materials. Alternatively, the raised supporting bodies can be made of the same material as that of the mask 1 and are integrally formed with the mask 1. Finally, on the same side as that of the raised supporting bodies 11, the plate surface of the mask 1 is provided with an electrode layer 13. The electrode layer 13 is formed on the plate surface of the mask 1 by means of a metal sputtering method to avoid the positions of the raised supporting bodies 11. The surface of the raised supporting bodies 11 on one side of the mask 1 is also plated with an electrode layer 13. Via this arrangement, when the raised supporting bodies 11 are adhered to the cathode plate 1, they are electrically connected with the electrodes on the cathode plate 3 to provide a power supply for the electrode layer 13. In this way, the electrode layer 13 acts as a gate electrode to drain the cathode plate 3 to generate electron beams for colliding with the anode plate 2.

FIG. 3 is an assembled view showing the structure of the present invention, and FIG. 4 is a schematic view showing the operation of the present invention. As shown in FIG. 3, the mask 1 is provided between the anode plate 2 and the cathode plate 3. The anode plate 2 further includes an anode substrate 21 thereon. The plate surface of the substrate 21 is provided with an electrode layer 22 and a fluorescent layer 23. The anode plate 3 further includes a cathode substrate 31. The plate surface of the substrate 31 has thereon an electrode layer 32 and a plurality of cathode electron emission sources 33. After the mask 1 is connected with the cathode substrate 31, the cathode electron emission sources 33 correspond to the apertures 11 on the mask 1, and the raised supporting bodies 12 of the mask 1 are adhered to the surface of the cathode substrate 31, so as to form a support and separation between the mask 1 and the cathode plate 3. Further, the electrode layer 13 provided on the surface of the raised supporting bodies 12 of one side of the mask 1 is electrically connected with the electrode layer 32 on the cathode substrate 31. As a result, as shown in FIG. 4, after the electrode layer 13 on the surface of the mask 1 is supplied with electricity, a gate electrode is formed to drain the cathode electron emission sources 33 to generate electron beams 40 that pass through the apertures 11 of the mask 1 and collide with the fluorescent layer 23 of the anode substrate 21 directly, thereby generating an effect of emitting light by itself.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A mask structure having raised supporting bodies, provided between an anode plate and a cathode plate and comprising:
a mask (1);
a plurality of apertures (11) arranged on the mask (1) at intervals;
a plurality of raised supporting bodies (12) arranged on a surface of the mask (1) at intervals and adhered to the cathode plate (3) so as to act as a support for the mask (1) and form a separation with the cathode plate (3); and
an electrode layer (13) provided on the mask (1) and located on the surface of the same side as the raised supporting bodies (12) to avoid positions of the raised supporting bodies (12), the surface of the raised supporting bodies (12) on one side of the mask (1) being provided with an electrode layer (13) for electrically connecting with the cathode plate (3).

2. The mask structure having raised supporting bodies according to claim 1, wherein a thickness of the mask (1) is in a range between 0.02 mm and 2 mm.

3. The mask structure having raised supporting bodies according to claim 1, wherein a diameter of the aperture (11) is in a range between 1 μm and 2 μm.

4. The mask structure having raised supporting bodies according to claim 1, wherein a height of the raised supporting body (12) is in a range between 1 μm and 50 μm.

5. The mask structure having raised supporting bodies according to claim 1, wherein the raised supporting body (12) is made of an insulating material.

6. The mask structure having raised supporting bodies according to claim 1, wherein the raised supporting body (12) is made of silicon dioxide.

7. The mask structure having raised supporting bodies according to claim 1, wherein the raised supporting body (12) is made of glass.
